(19) United States
(12) Patent Application Publication
(10) Pub. No.: US 2017/0244517 A1
(43) Pub. Date: Aug. 24, 2017

(54) METHOD AND DEVICE FOR REDUCING BLIND DECODING COMPLEXITY FOR COVERAGE ENHANCED-MTC DEVICE

(71) Applicant: ALCATEL LUCENT, Boulogne Billancourt (FR)

(72) Inventors: Shin Horng Wong, Chippenham (GB); Yu Chen, Shanghai (CN); Matthew Baker, Canterbury (GB)

(73) Assignee: Alcatel Lucent, Boulogne Billancourt (FR)

(21) Appl. No.: 15/513,337

(22) PCT Filed: Sep. 9, 2015
(86) PCT No.: PCT/IB2015/001927

§ 371 Date: Mar. 22, 2017

(30) Foreign Application Priority Data
Sep. 26, 2014 (CN) 201410505343.3

(51) Int. Cl. H04L 1/00; H04L 1/08; H04W 4/00

(52) U.S. Cl. CPC H04L 1/0038; H04W 4/005; H04L 1/08

(57) ABSTRACT

The embodiments according to the present invention provide a method for being implemented at a Coverage Enhanced-Machine Type Communication device. The method comprises receiving information related with Total Aggregated Resource from a network device; and determining, according to the Total Aggregated Resource, the number of time domain repetitive transmissions for each aggregation level in a set of candidate aggregation levels, so as to blind decode an enhanced physical downlink control channel, wherein the aggregation level and the number of time domain repetitive transmissions are in an inverse proportional relation. The embodiments of the present invention further provide a corresponding method at a network device and corresponding apparatuses.

### FIELD OF THE INVENTION

The embodiments of the present invention relate to the field of wireless communication, and more specifically, to a method and module for reducing blind decoding complexity for a Coverage Enhanced-Machine Type Communication (MTC) device.

### BACKGROUND OF THE INVENTION

A Machine Type Communication (MTC) device is a UE (user equipment) used by a machine for specific application. An example of such a MTC device is a smart meter. Some of these smart meters are located in basement, which suffer from high penetration loss and therefore it is difficult for the MTC device to communicate with the network. Therefore, in 3GPP, a new Work Item (WI) for Low Cost MTC UE and coverage enhancement is approved. The coverage enhancement aspect aims at extending the coverage of such a MTC UE by 15 dB and this WI is expected to continue in the following version of 3GPP. These UEs may be termed as a Coverage Enhanced-Machine Type Communication UE (CE-MTC UE).

In 3GPP protocols, an enhanced physical downlink control channel (EPDCCH) is defined. EPDCCH is a downlink channel containing scheduling information for UE (a physical downlink shared channel (EPDCCH) and a physical uplink shared channel (PDSCH)). Currently, to provide scheduling flexibility and different target coverage, EPDCCH has several candidates where the candidates have different aggregation levels (AL) and occupy different frequency resources. The aggregation level of a candidate of an EPDCCH is the number of repetitive transmissions in frequency of an EPDCCH sample, and a network device such as eNB (evolved NodeB) uses the aggregation level to adapt to the radio condition of the UE. Such scheduling flexibility at the eNB would require the UE to blind decode a finite set of EPDCCH candidate channels.

Repetitive transmission of physical channels is the main mechanism to extend the coverage of MTC UEs. EPDCCH would also comprise repetitive transmissions in time domain and the number of repetitive transmissions is dependent upon the required coverage enhancement. In order to maintain scheduling flexibility, during Rel-12 WI, it is considered that the aggregation level and/or the number of time repetitive transmissions can be changed by the eNB. However, this apparently increase the complexity of the MTC device, since in addition to blind decoding the candidate channels in frequency domain (repetitive transmissions in frequency domain), the MTC device also has to blind decode the repetitive transmissions in time domain.

In the prior art, there is already proposed a solution for reducing blind decoding complexity. In the solution, the number of possible candidate aggregation levels (the candidates of EPDCCH in frequency domain) is reduced for a UE, and only a high aggregation level is used. For example, only AL 8 is selected to transmit EPDCCH. However, using only a high aggregation level would cause a large number of common resources (e.g. PDCCH) to be occupied for duration of the repetitive transmissions and may leave less PDCCH resources for legacy UE. This would increases the delay in scheduling legacy UE. Furthermore, for a MTC device, such restriction on AL would also reduce scheduling flexibility of a network device, such as eNB.

### SUMMARY OF THE INVENTION

In order to solve one or more problems existing in the prior art, a solution adapted for reducing blind decoding complexity for Coverage Enhanced-MTC device is proposed according to embodiments of the present invention.

According to one aspect of the present disclosure, there is provided a method for being implemented at a Coverage Enhanced-Machine Type Communication device. The method comprises: receiving information related with Total Aggregated Resource from a network device; and determining, according to the Total Aggregated Resource, the number of time domain repetitive transmissions for each aggregation level in a set of candidate aggregation levels, so as to blind decode an enhanced physical downlink control channel, wherein the aggregation level and the number of time domain repetitive transmissions are in an inverse proportional relation.

According to another aspect of the present disclosure, there is provided a method for being implemented at a network device. The method comprises: transmitting information related with Total Aggregated Resource to a Coverage Enhanced-Machine Type Communication device, such that the Coverage Enhanced-Machine Type Communication device is able to determine, according to the Total Aggregated Resource, the number of time domain repetitive transmissions for each aggregation level in a set of candidate aggregation levels, so as to blind decode an enhanced physical downlink control channel, wherein the aggregation level and the number of time domain repetitive transmissions are in an inverse proportional relation.

According to another aspect of the present disclosure, there is provided a Coverage Enhanced-Machine Type Communication device. The device comprises: a receiving unit configured to receive information related with Total Aggregated Resource from a network device; and a determining unit configured to determine, according to the Total Aggregated Resource, the number of time domain repetitive transmissions for each aggregation level in a set of candidate aggregation levels, so as to blind decode an enhanced physical downlink control channel, wherein the aggregation level and the number of time domain repetitive transmissions are in an inverse proportional relation.

According to another aspect of the present disclosure, there is provided a network device. The network device comprises: a transmitting unit configured to transmit information related with Total Aggregated Resource to a Coverage Enhanced-Machine Type Communication device, such that the Coverage Enhanced-Machine Type Communication device is able to determine, according to the Total Aggregated Resource, the number of time domain repetitive transmissions for each aggregation level in a set of candidate aggregation levels, so as to blind decode an enhanced physical downlink control channel, wherein the aggregation level and the number of time domain repetitive transmissions are in an inverse proportional relation.

According to various embodiments of the present invention, different numbers of repetitive transmissions in time domain may be used for different aggregation levels at the Coverage Enhanced-Machine Type Communication device by defining a relation between the aggregation level of an enhanced physical downlink control channel and the number of repetitive transmissions of the enhanced physical downlink control channel in time domain, thereby reducing blind decoding complexity of the enhanced physical downlink control channel.

### BRIEF DESCRIPTION OF THE DRAWINGS

FIG. 1 is a flow chart of a method performed at a Coverage Enhanced-MTC device according to an embodiment of the present disclosure;

FIG. 2 schematically illustrates blind decoding performed by a Coverage Enhanced-MTC device according to an embodiment of the present disclosure;

FIG. 3 is a flow chart of a method performed at a network device according to an embodiment of the present disclosure;

FIG. 4 is a schematic block diagram of a Coverage Enhanced-MTC device according to an embodiment of the present invention; and

FIG. 5 is a schematic block diagram of a network device according to an embodiment of the present invention.

### DETAILED DESCRIPTION OF THE PREFERRED EMBODIMENTS

In order to solve one or more problems existing in the prior art, embodiments according to the present invention propose defining a relation between the aggregation level (AL) of EPDCCH and the number of repetitive transmissions of the EPDCCH in time domain, such that, given a parameter (for example, the aggregation level), a MTC device can derive the other parameter (for example, the number of repetitive transmissions in time domain) adapt to it. Such a relation may be signaled to the MTC device by a network device, and thereby utilized by the MTC device to reduce the complexity of EPDCCH blind decoding.

In one embodiment, the network device such as eNB informs the MTC device of Total Aggregated Resource (TAR). TAR may be defined for EPDCCH decoding candidates, such that the TAR is given by Sum (aᵢ), i=0, . . . , T−1, wherein Sum (·) is a sum function, T is the number of repetitive transmissions in time domain and in frequency domain, and aᵢ is the resource amount in a subframe i.

The MTC device receives information related with the TAR required by it from the network device. For a given TAR value, the aggregation level (AL) and the number of repetitive transmissions in time domain N_{R} is in an inverse proportion relation. For example, for a given TAR value, the number of repetitive transmissions in time domain N_{R} may be represented as follows:

$${N}_{R} = \frac{TAR}{AL} \qquad 1 )$$

In one implementation, in the system, for example, there may be a plurality of predefined TAR values, and the network device allocates a respective TAR value to a UE according to requirements. In another implementation, TAR may be a function of the aggregation level (AL). The network device may inform the UE of the function, or may predefine a function relation between the TAR and the aggregation level (AL), so that both the communicating parties know the function relation. In one implementation, the TAR for different devices may be a variable for a specific available aggregation level. Currently, a possible AL value is a power of 2, namely AL={1, 2, 4, 8, 16}. Accordingly, the MTC device only has limited number of ALs to be blind decoded.

Thereby, for a given TAR value, the MTC device may determine the number of repetitive transmissions in time domain N_{R} according to the equation 1), i.e., it is known when to stop accumulating EPDCCH samples of the aggregation level (AL) repeated in time domain. Specifically, for a given TAR value, a higher aggregation level (AL) value may correspond to a smaller number of the repetitive transmissions in time domain N_{R}, as compared to a lower aggregation level (AL) value. Hence, the MTC device using the higher aggregation level (AL) value may stop accumulating EPDCCH samples repeated in time domain earlier.

In some preferred embodiments, the TAR value signaled by the network device may cause the number of repetitive transmissions in time domain N_{R} obtained for each aggregation level (AL) to be an integer. For example, a result obtained by dividing TAR by AL in the equation 1) is required to be an integer.

Since the maximum number of time domain repetitive transmissions corresponds to the minimum aggregation level according to the equation 1), the TAR value in some embodiments may be defined using the minimum aggregation level AL_{MIN} and the maximum number of time domain repetitive transmissions N_{RMAX}, as an equation 2a):

$${N}_{R} = \frac{TAR}{AL} = \frac{{AL}_{MIN} \times {N}_{RMAX}}{AL} \qquad 2 a )$$

Similarly, since the minimum number of time domain repetitive transmissions corresponds to the maximum aggregation level, the TAR value may also be defined using the maximum aggregation level AL_{MAX} and the minimum number of time domain repetitive transmissions N_{RMIN}, as an equation 2b):

$${N}_{R} = \frac{TAR}{AL} = \frac{{AL}_{MAX} \times {N}_{RMIN}}{AL} \qquad 2 b )$$

Thereby, in the case that a value range of the AL is known, the network device, for example, may inform the TAR value by signaling to the MTC device the maximum number of time domain repetitive transmissions N_{RMAX} or the minimum number of time domain repetitive transmissions N_{RMIN}.

In the equations 1), 2a) and 2b), the relation between the aggregation level and the number of time domain repetitive transmissions is defined as a linear relation. However, as a matter of fact, there may be a non-linear relation between the aggregation level and the number of time domain repetitive transmissions. When the aggregation level is relatively small, more transmissions may be required as compared to the number of time domain repetitive transmissions determined from the linear relation. According to one embodiment, in order to compensate non-linear characteristics between the number of time domain repetitive transmissions and the aggregation level, a compensating factor C_{AL} may be introduced:

$${N}_{R} = {C}_{AL} \frac{TAR}{AL} \qquad 3 )$$

wherein the non-linear compensating factor C_{AL} may be informed to a respective MTC device by the network device, or may be predefined for a specific number of time domain repetitive transmissions and a aggregation level. The MTC device may determine the accumulated number of time domain repetitive transmissions required for performing EPDCCH blind decoding using a respective non-linear compensating parameter according to the equation 3).

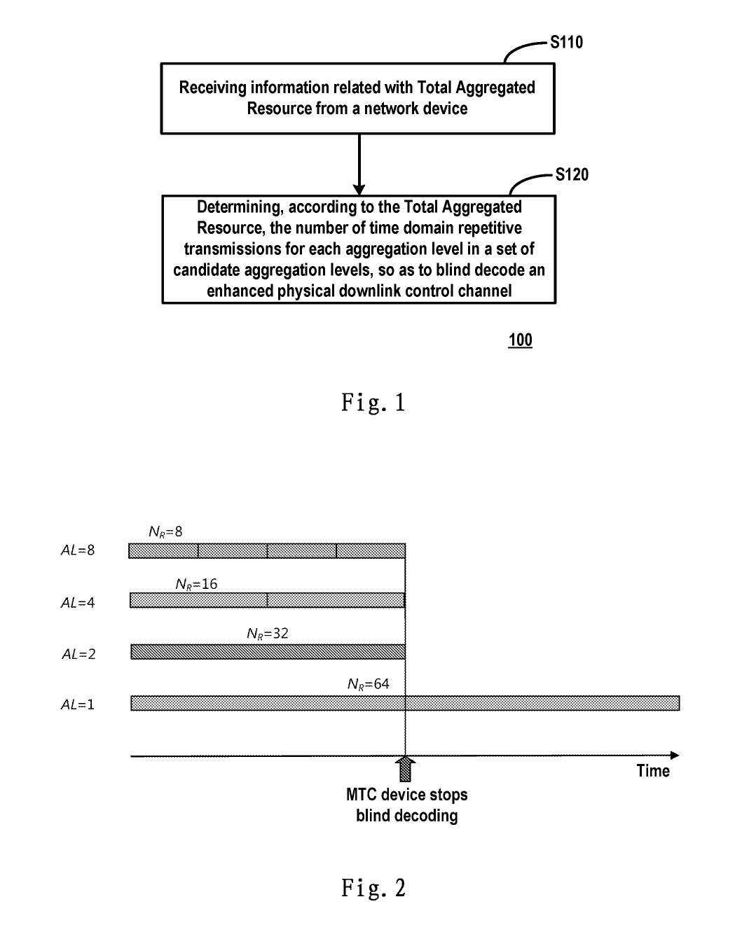

FIG. 1 is a flow chart of a method 100 performed at a Coverage Enhanced-MTC device according to an embodiment of the present disclosure.

As shown in FIG. 1, in step S110, the Coverage Enhanced-MTC device receives information related with Total Aggregated Resource from the network device.

According to an embodiment of the present disclosure, the Total Aggregated Resource (TAR) value for the Coverage Enhanced-MTC device may be defined using the minimum aggregation level AL_{MIN} and the maximum number of time domain repetitive transmissions N_{RMAX}. When a set of the candidate aggregation levels of the Coverage Enhanced-MTC device is known, the Coverage Enhanced-MTC device may determine the TAR value by receiving the maximum number of time domain repetitive transmissions N_{RMAX} from the network device. In an example, the Total Aggregated Resource is equal to a product of the minimum aggregation level and the maximum number of time domain repetitive transmissions (see the above equation 2a).

In another embodiment of the present disclosure, the Total Aggregated Resource (TAR) value for the Coverage Enhanced-MTC device may be defined using the maximum aggregation level AL_{MAX} and the minimum number of time domain repetitive transmissions N_{RMIN}. Likewise, when a set of the candidate aggregation levels of the Coverage Enhanced-MTC device is known, the Coverage Enhanced-MTC device may determine the TAR value by receiving the minimum number of time domain repetitive transmissions N_{RMIN} from the network device. In an example, the Total Aggregated Resource is equal to a product of the maximum aggregation level and the minimum number of time domain repetitive transmissions (see the above equation 2b).

In various embodiments of the present invention, a set of candidate aggregation levels required by the Coverage Enhanced-MTC device may be preset according to a device type (for example, defined in respective specifications); or may be assigned by a network device such as eNB and signaled to the Coverage Enhanced-MTC device. Therefore, in an embodiment, though not shown in the figures, the flow of FIG. 1 may further include a step that the Coverage Enhanced-MTC device receives a set of the candidate aggregation levels from the network device. Regardless of which embodiment is followed, for a specific UE, its available set of the candidate aggregation levels is a limited set.

In step S120, the Coverage Enhanced-MTC device determine, according to the Total Aggregated Resource, the number of time domain repetitive transmissions for each aggregation level in the set of candidate aggregation levels, wherein the aggregation level and the number of time domain repetitive transmissions are in an inverse proportional relation.

According to one embodiment of the present invention, for a given Total Aggregated Resource, the aggregation level (AL) and the number of time domain repetitive transmissions N_{R} satisfy the equation 1):

$${N}_{R} = \frac{TAR}{AL} \qquad 1 )$$

wherein TAR represents Total Aggregated Resource, and AL represents an aggregation level.

In a specific example, the set of candidate aggregation levels of the Coverage Enhanced-MTC device is AL={1, 2, 4, 8}. The maximum number of time domain repetitive transmissions N_{MAX} received by the Coverage Enhanced-MTC device from the network device is 64. The Coverage Enhanced-MTC device may determine the TAR value (which is 64) by using a product of the minimum aggregation level AL_{MIN} and the maximum number of time domain repetitive transmissions N_{RMAX} (see the above equation 2a). The Coverage Enhanced-MTC device may know the number of time domain repetitive transmissions for each aggregation level according to the equation 1), as shown in table 1.

TABLE 1

| AL | N_{R} |
|---|---|
| 1 | 64 |
| 2 | 32 |
| 4 | 16 |
| 8 | 8 |

FIG. 2 schematically illustrates blind decoding performed by a Coverage Enhanced-MTC device according to an embodiment of the present disclosure.

As shown in FIG. 2, the Coverage Enhanced-MTC device will perform blind decoding for all the candidate aggregation levels (AL). Suppose that the network device eNB uses AL=2 to schedule EPDCCH. The Coverage Enhanced-MTC device cannot know this specific scheduling and then will perform blind decoding for all the candidate aggregation levels (AL), and stops the blind decoding process once EPDCCH is successfully decoded in the blind decoding process. In the above specific example as described referring to the table 1, the Coverage Enhanced-MTC device should stop its blind decoding process when the EPDCCH repetitive samples with the number of time domain repetitive transmissions N_{R}=32 (corresponding to AL=2) are accumulated. As 32 EPDCCH repetitive samples are accumulated, the blind decoding is performed four times during this blind decoding duration, for the aggregation level AL=8, and the EPDCCH repetitive samples with the number of time domain repetitive transmissions N_{R}=8 are accumulated each time; whereas for the aggregation level AL=4, the blind decoding is performed twice and the EPDCCH repetitive samples with the number of time domain repetitive transmissions N_{R}=16 are accumulated each time. For the aggregation level AL=1, since the EPDCCH is successfully decoded when the respective number of time domain repetitive transmissions N_{R}=64 has not been accumulated yet, it is unnecessary for the Coverage Enhanced-MTC device to continue performing the blind decoding for the aggregation level AL=1. It can be seen that, according to the various embodiments of the present invention, the blind decoding complexity of the enhanced physical downlink control channel may be effectively controlled and reduced by defining the relation between the aggregation level of the enhanced physical downlink control channel and the number of the repetitive transmissions of the enhanced physical downlink control channel in time domain.

According to another embodiment of the present invention, considering the non-linear characteristics between the aggregation level and the number of time domain repetitive transmissions, a compensating factor C_{AL} may be introduced for compensating the non-linear characteristics between the number of time domain repetitive transmissions and the aggregation level. Given Total Aggregated Resource, the aggregation level AL and the number of time domain repetitive transmissions satisfies the equation 3):

$${N}_{R} = {C}_{AL} \frac{TAR}{AL} \qquad 3 )$$

wherein TAR represents Total Aggregated Resource, AL represents an aggregation level, and C_{AL} is a non-linear compensating factor which is set for each AL value. In the specific implementation, those skilled in the art may determine the non-linear compensating factor C_{AL} for each AL according to statistic measurements and empirical values. Those skilled in the art may determine a specific value of the non-linear compensating factor C_{AL} in any proper manner. In some implementations, the non-linear compensating factor C_{AL} may be defined in specific specifications or predefined in the system, or also may be informed to a respective MTC device by the network device.

In one specific example, a set of candidate aggregation levels of the Coverage Enhanced-MTC device is AL={1, 2, 4, 8}. If the maximum number of time domain repetitive transmissions N_{RMAX} received by the Coverage Enhanced-MTC device from the network device is 64, the Coverage Enhanced-MTC device may determine the TAR value as 64 using a product of the minimum aggregation level AL_{MIN} and the maximum number of time domain repetitive transmissions N_{RMAX} (see the above equation 2a). At this time, the equation 3) may be expanded as follows:

$${N}_{R} = {C}_{AL} \frac{TAR}{AL} = {C}_{AL} \frac{{AL}_{M IN} \times {N}_{RMAX}}{AL} \qquad 3 a )$$

Similarly, if the minimum number of time domain repetitive transmissions N_{RMIN} received by the Coverage Enhanced-MTC device from the network device is 8. The Coverage Enhanced-MTC device may determine the TAR value as 64 using a product of the maximum aggregation level AL_{MAX} and the minimum number of time domain repetitive transmissions N_{RMIN} (see the above equation 2b). At this time, the equation 3) may be expanded as:

$${N}_{R} = {C}_{AL} \frac{TAR}{AL} = {C}_{AL} \frac{{AL}_{M AX} \times {N}_{RMIN}}{AL} \qquad 3 b )$$

Table 2 shows a specific example of determining the number of time domain repetitive transmissions for each aggregation level considering a non-linear compensating factor C_{AL}.

TABLE 2

| AL | C_{AL} | N_{R} |
|---|---|---|
| 1 | 1.5 | 96 |
| 2 | 1.2 | 39 |
| 4 | 1.1 | 18 |
| 8 | 1 | 8 |

In some embodiments, supposing that the repetitive transmissions of EPDCCH are started at a subframe S_{SUB} of SFN (System Frame Number) S_{SFN}, each N_{R} determined by the Coverage Enhanced-MTC device according to the above mentioned various embodiments may be applied to determine a starting position of the EPDCCH repetitive transmissions, i.e., it satisfies:

(S_{SFN}+S_{SUB})MOD N_{R}=0 4)

wherein MOD (·) is a modular operation.

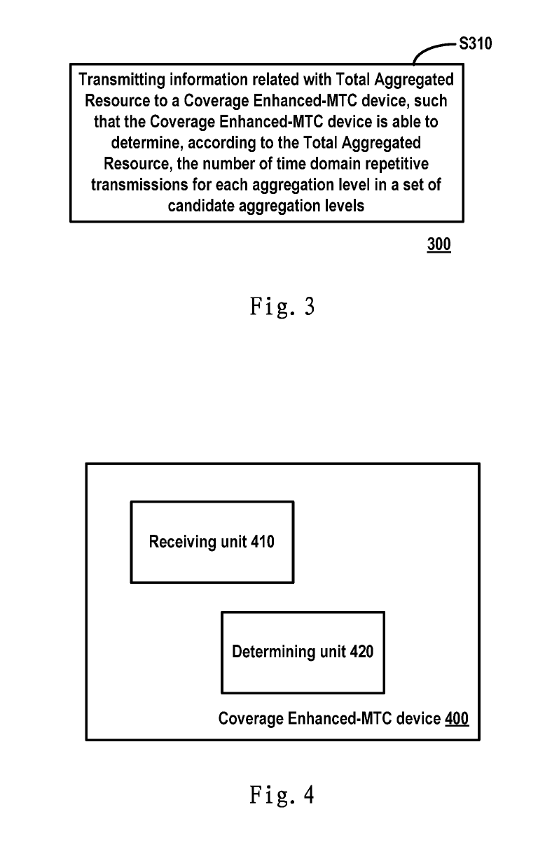

FIG. 3 is a flow chart of a method 300 performed at a network device according to an embodiment of the present disclosure.

As shown in FIG. 3, at step S310, a network device such as eNB transmits information related with the Total Aggregated Resource to a Coverage Enhanced-MTC device, such that the Coverage Enhanced-MTC device is able to determine the number of time domain repetitive transmissions for each aggregation level in a set of candidate aggregation levels according to the Total Aggregated Resource, so as to blind decode the enhanced physical downlink control channel. According to various embodiments of the present disclosure, the aggregation level and the number of time domain repetitive transmissions are in an inverse proportional relation.

According to one embodiment of the present disclosure, the above step S310 may comprise transmitting the maximum number of time domain repetitive transmissions to the Coverage Enhanced-MTC device, wherein the Total Aggregated Resource is equal to a product of the minimum aggregation level and the maximum number of time domain repetitive transmissions.

According to another embodiment of the present disclosure, the above step S310 may comprise transmitting the minimum number of time domain repetitive transmissions to the Coverage Enhanced-MTC device, wherein the Total Aggregated Resource is equal to a product of the maximum aggregation level and the minimum number of time domain repetitive transmissions.

According to one embodiment of the present disclosure, in a step not shown in FIG. 3, the network device may also transmit a set of candidate aggregation levels of the Coverage Enhanced-MTC device to the Coverage Enhanced-MTC device.

According to one embodiment of the present disclosure, for Total Aggregated Resource, an aggregation level and the number of time domain repetitive transmissions satisfy an equation 1):

$${N}_{R} = \frac{TAR}{AL} , \qquad 1 )$$

wherein TAR represents Total Aggregated Resource, and AL represents an aggregation level.

According to one embodiment of the present disclosure, for Total Aggregated Resource, an aggregation level and the number of time domain repetitive transmissions satisfy an equation 3):

$${N}_{R} = {C}_{AL} \frac{TAR}{AL} , \qquad 3 )$$

wherein TAR represents Total Aggregated Resource, AL represents an aggregation level, and C_{AL} is a non-linear compensating factor which is set for each AL value.

In one embodiment, the network device may transmit to a Coverage Enhanced-MTC device a non-linear compensating factor which is set for each aggregation level in a set of candidate aggregation levels.

FIG. 4 is a schematic block diagram of a Coverage Enhanced-MTC device 400 according to an embodiment of the present invention.

As shown in FIG. 4, a Coverage Enhanced-MTC device 400 comprises a receiving unit 410 and a determining unit 420. The receiving unit 410 is configured to receive information related with Total Aggregated Resource from a network device. The determining unit 420 is configured to determine, according to the Total Aggregated Resource, the number of time domain repetitive transmissions of each aggregation level in a set of candidate aggregation levels, so as to blind decode an enhanced physical downlink control channel. The determining unit 420 performs the determination using an inverse proportional relation between an aggregation level and the number of time domain repetitive transmissions.

In one embodiment, the receiving unit 410 may be configured to receive a set of candidate aggregation levels from the network device.

According to one embodiment of the present disclosure, the receiving unit 410 may be configured to receive information related with the Total Aggregated Resource from the network device by receiving the maximum number of time domain repetitive transmissions from the network device. In this embodiment, the Total Aggregated Resource is equal to a product of the minimum aggregation level and the maximum number of time domain repetitive transmissions.

According to another embodiment of the present disclosure, the receiving unit 410 may be configured to receive information related with Total Aggregated Resource from a network device by receiving the minimum number of time domain repetitive transmissions from the network device. In this embodiment, the Total Aggregated Resource is equal to a product of the maximum aggregation level and the minimum number of time domain repetitive transmissions.

According to one embodiment of the present disclosure, the determining unit 420 may be configured to determine, for Total Aggregated Resource and according to an equation 1), the number of time domain repetitive transmissions for each aggregation level in a set of candidate aggregation levels:

$${N}_{R} = \frac{TAR}{AL} \qquad 1 )$$

wherein TAR represents Total Aggregated Resource, and AL represents an aggregation level.

According to another embodiment of the present disclosure, the determining unit 420 may be configured to determine, for Total Aggregated Resource and according to an equation 3), the number of time domain repetitive transmissions for each aggregation level in a set of candidate aggregation levels:

$${N}_{R} = {C}_{AL} \frac{TAR}{AL} \qquad 3 )$$

wherein TAR represents Total Aggregated Resource, AL represents an aggregation level, and C_{AL} is a non-linear compensating factor which is set for each AL value.

According to this embodiment, C_{AL} may be predefined, thereby it is known by the Coverage Enhanced-MTC device 400; and optionally, the receiving unit 410 may also be configured to receive from the network device a non-linear compensating factor which is set for each aggregation level in a set of candidate aggregation levels.

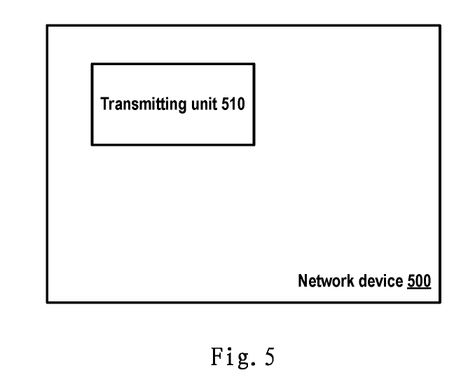

FIG. 5 is a schematic block diagram of a network device 500 according to an embodiment of the present disclosure.

As shown in FIG. 5, a network device 500 comprises a transmitting unit 510. The transmitting unit 510 is configured to transmit information related with Total Aggregated Resource to a Coverage Enhanced-MTC device, such that the Coverage Enhanced-MTC device is able to determine the number of time domain repetitive transmissions for each aggregation level in a set of candidate aggregation levels according to the Total Aggregated Resource, so as to blind decode an enhanced physical downlink control channel. In various embodiments of the present disclosure, an aggregation level and the number of time domain repetitive transmissions are in an inverse proportional relation.

According to the embodiments of the present disclosure, the transmitting unit 510 may be further configured to transmit to the Coverage Enhanced-MTC device a set of candidate aggregation levels of the Coverage Enhanced-MTC device.

According to one embodiment of the present disclosure, the transmitting unit 510 may be configured to transmit information related with Total Aggregated Resource to the Coverage Enhanced-MTC device by transmitting to the Coverage Enhanced-MTC device the maximum number of time domain repetitive transmissions. In this embodiment, the Total Aggregated Resource is equal to a product of the minimum aggregation level and the maximum number of time domain repetitive transmissions.

According to one embodiment of the present disclosure, the transmitting unit 510 may be configured to transmit information related with Total Aggregated Resource to the Coverage Enhanced-MTC device by transmitting to the Coverage Enhanced-MTC device the minimum number of time domain repetitive transmissions. In this embodiment, the Total Aggregated Resource is equal to a product of the maximum aggregation level and the minimum number of time domain repetitive transmissions.

According to one embodiment of the present disclosure, for Total Aggregated Resource, an aggregation level and the number of time domain repetitive transmissions satisfy an equation 1):

$${N}_{R} = \frac{TAR}{AL} \qquad 1 )$$

wherein TAR represents Total Aggregated Resource, and AL represents an aggregation level.

According to one embodiment of the present disclosure, for Total Aggregated Resource, an aggregation level and the number of time domain repetitive transmissions satisfy an equation 3):

$${N}_{R} = {C}_{AL} \frac{TAR}{AL} \qquad 3 )$$

wherein TAR represents Total Aggregated Resource, AL represents an aggregation level, and C_{AL} is a non-linear compensating factor which is set for each AL value.

According to this embodiment, C_{AL} may be predefined, thereby it is known by the Coverage Enhanced-MTC device; and optionally, the transmitting unit 510 may be further configured to transmit to the Coverage Enhanced-MTC device a non-linear compensating factor which is set for each aggregation level in a set of candidate aggregation levels.

The Coverage Enhanced-MTC device 400 and the network device 500 according to various embodiments of the present invention may further comprise components or functional modules for implementing conventional functions of a UE, for example, an antenna, a radio frequency processing module, a baseband processing module, a processor such as a microcontroller and a signal processor, a storage, etc. In some embodiments, the functionalities of these conventional functional modules may be combined to realize one or more functional units as shown in FIG. 4 and FIG. 5 (omitted herein).

The embodiments of the present invention can be implemented in software, hardware, application logic or a combination of software, hardware and application logic. In an exemplary embodiment, the application logic, software or an instruction set is maintained in any one of conventional computer readable media. In the context herein, “computer readable media” may be any medium or means capable of containing, storing, transferring, propagating or transmitting instructions used by or related to an instruction executing system, device or apparatus such as a computer. The computer readable media may comprise computer readable storage media which may be any medium or means capable of containing or storing instructions used by or related to an instruction executing system, device or apparatus such as a computer.

If necessary, different functions discussed herein may be performed according to different orders and/or performed in parallel to one another. Moreover, if necessary, one or more functions from the above mentioned functions may be optional or may be combined.

Although various aspects of the present invention are set forth in independent claims, other aspects of the present invention include other combinations of features from the mentioned embodiments and/or dependent claims containing features of the independent claims, rather than only include the combinations explicitly illustrated in the claims.

It is also noted herein that, although the exemplary embodiments of the present invention are described in the foregoing, these descriptions should not be understood in a limiting sense. In contrast, various variants and modifications may be made without departing from the scope of the present invention as defined in the appended claims.

1. A method for being implemented at a Coverage Enhanced-Machine Type Communication device, comprising:
receiving information related with Total Aggregated Resource from a network device; and
determining, according to the Total Aggregated Resource, the number of time domain repetitive transmissions for each aggregation level in a set of candidate aggregation levels, so as to blind decode an enhanced physical downlink control channel,
wherein the aggregation level and the number of time domain repetitive transmissions are in an inverse proportional relation.

2. The method according to claim 1, further comprising:
receiving the set of candidate aggregation levels from the network device.

3. The method according to claim 1, wherein for the Total Aggregated Resource, the aggregation level AL and the number of time domain repetitive transmissions N_{R} satisfy:
$${N}_{R} = \frac{TAR}{AL} ,$$
in which TAR represents the Total Aggregated Resource, and AL represents an aggregation level.

4. The method according to claim 1, wherein for the Total Aggregated Resource, the aggregation level AL and the number of time domain repetitive transmissions N_{R} satisfy:
$${N}_{R} = {C}_{AL} \frac{TAR}{AL} ,$$
in which TAR represents the Total Aggregated Resource, AL represents an aggregation level, and C_{AL} is a non-linear compensating factor which is set for each AL value.

5. The method according to claim 3, further comprising:
receiving from the network device a non-linear compensating factor which is set for each aggregation level in the set of candidate aggregation levels.

6. The method according to claim 1, wherein receiving information related with the Total Aggregated Resource received from the network device comprises:
receiving the maximum number of time domain repetitive transmissions from the network device,
wherein the Total Aggregated Resource is equal to a product of the minimum aggregation level and the maximum number of time domain repetitive transmissions.

7. The method according to claim 1, wherein receiving information related with the Total Aggregated Resource received from the network device comprises:
receiving the minimum number of time domain repetitive transmissions from the network device,
wherein the Total Aggregated Resource is equal to a product of the maximum aggregation level and the minimum number of time domain repetitive transmissions.

8. A method for being implemented at a network device, comprising:
transmitting information related with Total Aggregated Resource to a Coverage Enhanced-Machine Type Communication device, such that the Coverage Enhanced-Machine Type Communication device is able to determine, according to the Total Aggregated Resource, the number of time domain repetitive transmissions for each aggregation level in a set of candidate aggregation levels, so as to blind decode an enhanced physical downlink control channel,
wherein the aggregation level and the number of time domain repetitive transmissions are in an inverse proportional relation.

9. The method according to claim 8, further comprising:
transmitting to the Coverage Enhanced-Machine Type Communication device the set of candidate aggregation levels of the Coverage Enhanced-Machine Type Communication device.

10. The method according to claim 8, wherein for the Total Aggregated Resource, the aggregation level and the number of time domain repetitive transmissions satisfy:
$${N}_{R} = \frac{TAR}{AL} ,$$
in which TAR represents the Total Aggregated Resource, and AL represents an aggregation level.

11. The method according to claim 8, wherein for the Total Aggregated Resource, the aggregation level and the number of time domain repetitive transmissions satisfy:
$${N}_{R} = {C}_{AL} \frac{TAR}{AL} ,$$
in which TAR represents the Total Aggregated Resource, AL represents an aggregation level, and C_{AL} is a non-linear compensating factor which is set for each AL value.

12. The method according to claim 11, further comprising:
transmitting to the Coverage Enhanced-Machine Type Communication device a non-linear compensating factor which is set for each aggregation level in the set of candidate aggregation levels.

13. The method according to claim 8, wherein transmitting the information related with the Total Aggregated Resource to the Coverage Enhanced-Machine Type Communication device comprises:
transmitting the maximum number of time domain repetitive transmissions to the Coverage Enhanced-Machine Type Communication device,
wherein the Total Aggregated Resource is equal to a product of the minimum aggregation level and the maximum number of time domain repetitive transmissions; and
transmitting the minimum number of time domain repetitive transmissions to the Coverage Enhanced-Machine Type Communication device,
wherein the Total Aggregated Resource is equal to a product of a maximum aggregation level and the minimum number of time domain repetitive transmissions.

14. (canceled)

15. A Coverage Enhanced-Machine Type Communication device, comprising:
a receiving unit configured to receive information related with Total Aggregated Resource from a network device; and
a determining unit configured to determine, according to the Total Aggregated Resource, the number of time domain repetitive transmissions for each aggregation level in a set of candidate aggregation levels, so as to blind decode an enhanced physical downlink control channel,
wherein the aggregation level and the number of time domain repetitive transmissions are in an inverse proportional relation.

16.-21. (canceled)

22. A network device, comprising:
a transmitting unit configured to transmit information related with Total Aggregated Resource to a Coverage Enhanced-Machine Type Communication device, such that the Coverage Enhanced-Machine Type Communication device is able to determine, according to the Total Aggregated Resource, the number of time domain repetitive transmissions for each aggregation level in a set of candidate aggregation levels, so as to blind decode an enhanced physical downlink control channel,
wherein the aggregation level and the number of time domain repetitive transmissions are in an inverse proportional relation.

23.-28. (canceled)
